(19) United States
(12) Patent Application Publication
(10) Pub. No.: US 2012/0026128 A1
(43) Pub. Date: Feb. 2, 2012

(54) DISPLAY SYSTEM HAVING A CAPACITIVE TOUCH PANEL AND MANUFACTURING METHODS OF THE SAME

(75) Inventors: Wen-Lung CHEN, Chu-Nan (TW); Yu-Chun TSENG, Chu-Nan (TW)

(73) Assignee: CHIMEI INNOLUX CORPORATION, Chu-Nan (TW)

(21) Appl. No.: 13/155,314

(22) Filed: Jun. 7, 2011

(30) Foreign Application Priority Data
Jul. 30, 2010 (TW) 099125474

(51) Int. Cl. G06F 3/045; H01H 11/00

(52) U.S. Cl. 345/174; 29/622

(57) ABSTRACT

A display system having a capacitive touch panel is described. The capacitive touch panel includes an electrode circuit formed on a substrate. The electrode circuit has a first electrode including a plurality of first conducting patterns and a second electrode including a plurality of second conducting patterns. The first conducting patterns are electrically connected to each other. A plurality of signal wires is formed on the substrate. A dielectric layer covers the electrode circuit. An electrode bridge structure is formed on the dielectric layer and is electrically connected to the second conducting patterns of the electric circuit, such that the second conducting patterns are electrically connected to each other. The electrode bridge structure having uniform thickness is formed by the metal open repair technique. A method of manufacturing a display system is also described.

This Application claims priority of Taiwan Patent Application No. TW9125474, filed on Jul. 30, 2010, the entirety of which is incorporated by reference herein.

### BACKGROUND OF THE INVENTION

1. Field of the Invention

The invention relates to a display system and a fabrication method thereof, and in particular to a display system having a capacitive touch panel and a manufacturing method thereof, wherein the capacitive touch panel includes an electrode bridge structure.

2. Description of the Related Art

Referring to FIG. 1, which is a cross section view of a conventional display system having a capacitive touch panel 100. The capacitive touch panel 100 includes a substrate 102, an indium tin oxide (ITO) layer 104, a metal wire 106, a dielectric layer 108, a stacked layer 110 and a passivation layer 112. The stacked layer 110 is composed of a conducting material. The ITO layer 104, the dielectric layer 108 and the stacked layer 110 are successively formed by physical vapor deposition (PVD) and photolithography processes, wherein the ITO layer 104 has a left-side electrode 104a and a right-side electrode 104b.

As shown in FIG. 1, however, the step coverage of the stacked layer 110 near the step edge between the dielectric layer 108 and the ITO layer 104 is poor. Namely, the stacked layer 110 has a non-uniform thickness due to the step height between the dielectric layer 108 and the ITO layer 104, so that the thickness of the stacked layer 110 near the step edge is smaller than that of the stacked layer 110 on the dielectric layer 108. Particularly, the step coverage of the stacked layer 110 is worsened when the thickness of the dielectric layer 108 is greater than that of the stacked layer 110, and thus the non-uniform thickness of the stacked layer 110 becomes more significant. As a result, resistance of the stacked layer 110 is increased with respect to that of the left-side electrode 104a and the right-side electrode 104b of the ITO layer 104, thereby degrading the signal transmission from the left-side electrode 104a to the metal wire 106 through the stacked layer 110 and the right-side electrode 104b, or from the right-side electrode 104b to the metal wire 106 through the stacked layer 110 and the left-side electrode 104a.

Furthermore, defects 11 are easily formed at contact interfaces between the two ends of the stacked layer 110 and the left and right-side electrodes 104a and 104b due to the poor step coverage of the stacked layer 110, resulting in a poor electrical contact therebetween and increasing the contact resistance between the stacked layer 110 and the ITO layer 104. As shown in FIG. 1, the stacked layer 110 is not in direct contact with the ITO layer 104, so that the left-side electrode 104a is electrically insulated from the right-side electrode 104b, and therefore, signals cannot be transmitted to the metal wire 106.

According to the above-mentioned descriptions, it must take care of the selection of the material of the stacked layer 110 and the control of the thicknesses of the ITO layer 104 and dielectric layer 108 due to the non-uniform thickness of the stacked layer 110 and the poor electrical contact between the stacked layer 110 and the ITO layer 104. Thus, the manufacturing process and material selection of the capacitive touch panel 100 are severely restricted. Although the thickness of the stacked layer 110 is increased to attempt to solve the mentioned problems in the prior art, the stacked layer 110 with an excessive thickness formed by performing a PVD and photolithography process would be stripped off, so that the problems of the poor step coverage of the stacked layer 110 and the poor electrical contact between the stacked layer 110 and the ITO layer 104 cannot be solved. Consequently, there is a need to improve the conventional capacitive touch panel.

### BRIEF SUMMARY OF THE INVENTION

A detailed description is given in the following embodiments with reference to the accompanying drawings. A first objective of the present invention is to provide a display system having a capacitive touch panel and a manufacturing method thereof, in which an electrode bridge structure is formed by a metal open repair technique for reducing the trace resistance of conducting patterns and improving the step coverage.

A second objective of the present invention is to provide a display system having a capacitive touch panel and a manufacturing method thereof, in which an electrode bridge structure is formed by a metal open repair technique to increase the material selection flexibility of the electrode bridge structure, dielectric layer and passivation layer, thereby improving the yield of the capacitive touch panel.

According to the above objectives, an exemplary embodiment of a display system having a capacitive touch panel comprises a substrate. An electrode circuit is formed on the substrate and has a first electrode along a first direction and a second electrode along a second direction, wherein the first electrode comprises a plurality of first conducting patterns electrically connected to each other and the second electrode comprises a plurality of second conducting patterns electrically insulated from the first electrode. A plurality of signal wires is formed on the substrate and is electrically connected to the first electrode and the second electrode of the electrode circuit. A dielectric layer is formed on the electrode circuit and partially covers the electrode circuit. An electrode bridge structure is formed on the dielectric layer and the electrode circuit, and is electrically connected to the second conducting patterns of the electrode circuit, such that the second conducting patterns are electrically connected to each other, wherein the electrode bridge structure has a thickness greater than that of the dielectric layer and the electrode bridge structure is electrically insulated from the first electrode of the electrode circuit by the dielectric layer.

An exemplary embodiment of a method of manufacturing a display system having a capacitive touch panel comprises forming a first conducting layer on a substrate. A second conducting layer is formed on the first conducting layer. The second conducting layer is patterned to form a plurality of signal wires and expose the first conducting layer. The first conducting layer is etched to form an electrode circuit having a first electrode along a first direction and a second electrode along a second direction, wherein the first electrode comprises a plurality of first conducting patterns electrically connected to each other and the second electrode comprises a plurality of second conducting patterns electrically insulated from the first electrode. A dielectric layer is formed on the electrode circuit to partially cover the electrode circuit. An electrode bridge structure is formed on the dielectric layer and the electrode circuit and is electrically connected to the second conducting patterns of the electrode circuit, such that the second conducting patterns are electrically connected to each other, wherein the electrode bridge structure has a thickness greater than that of the dielectric layer and the electrode bridge structure is electrically insulated from the first electrode of the electrode circuit by the dielectric layer.

### BRIEF DESCRIPTION OF DRAWINGS

The invention can be more fully understood by reading the subsequent detailed description and examples with references made to the accompanying drawings, wherein:

FIG. 1 is a cross section view of a conventional display system having a capacitive touch panel;

FIG. 2 is a plan view of a display system having a capacitive touch panel according to one embodiment of the present invention;

FIGS. 3A to 3F are cross section views of a method of manufacturing the capacitive touch panel shown in FIG. 2 along line A-A′ according to one embodiment of the present invention; and

FIG. 4 is a schematic block diagram of the display system having a capacitive touch panel according to one embodiment of the present invention.

### DETAILED DESCRIPTION OF DISCLOSURE

The following description is of the best-contemplated mode of carrying out the invention. This description is provided for the purpose of illustrating the general principles of the invention and should not be taken in a limiting sense. The scope of the invention is best determined by reference to the appended claims.

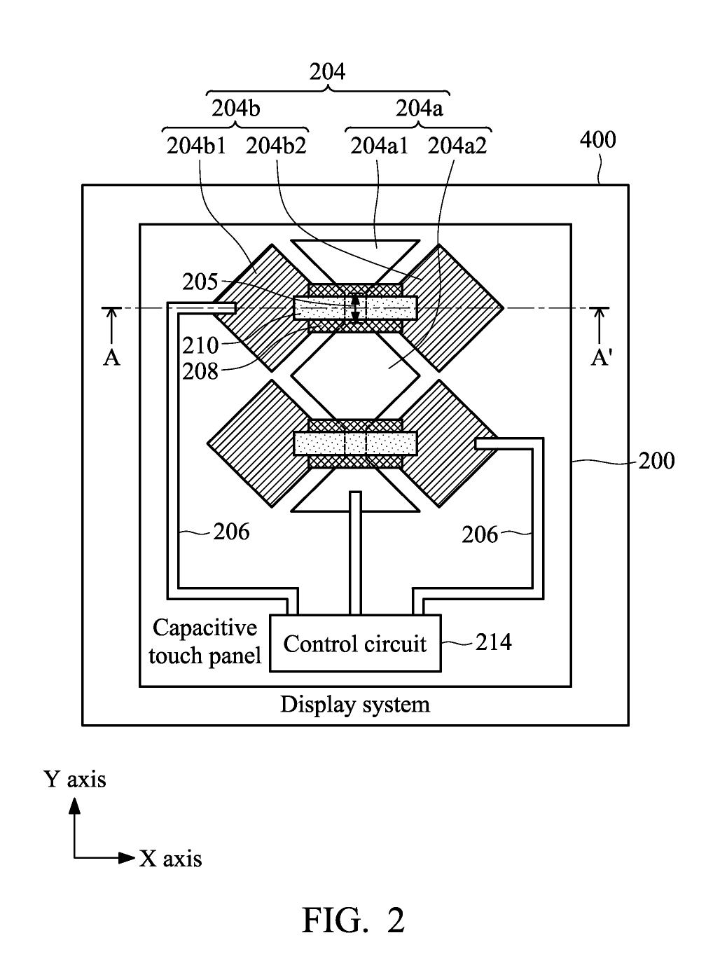

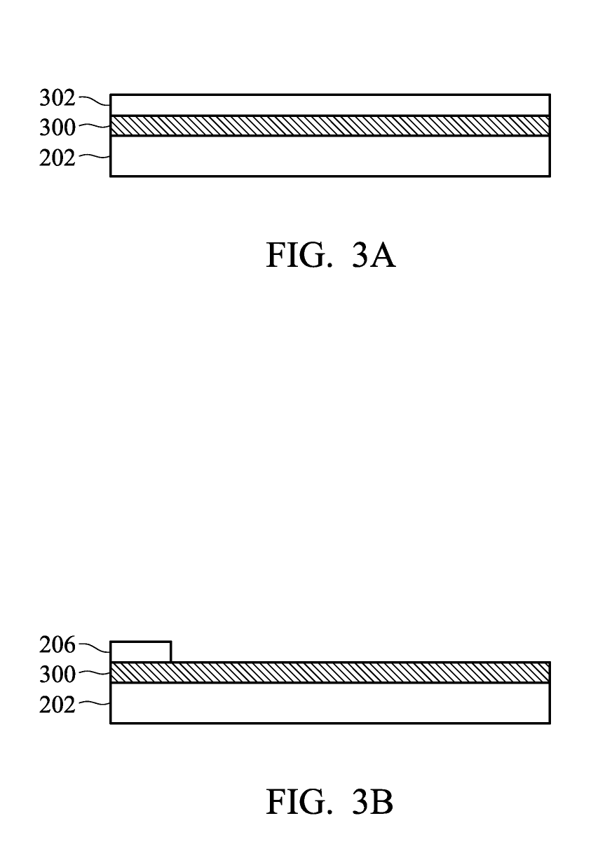

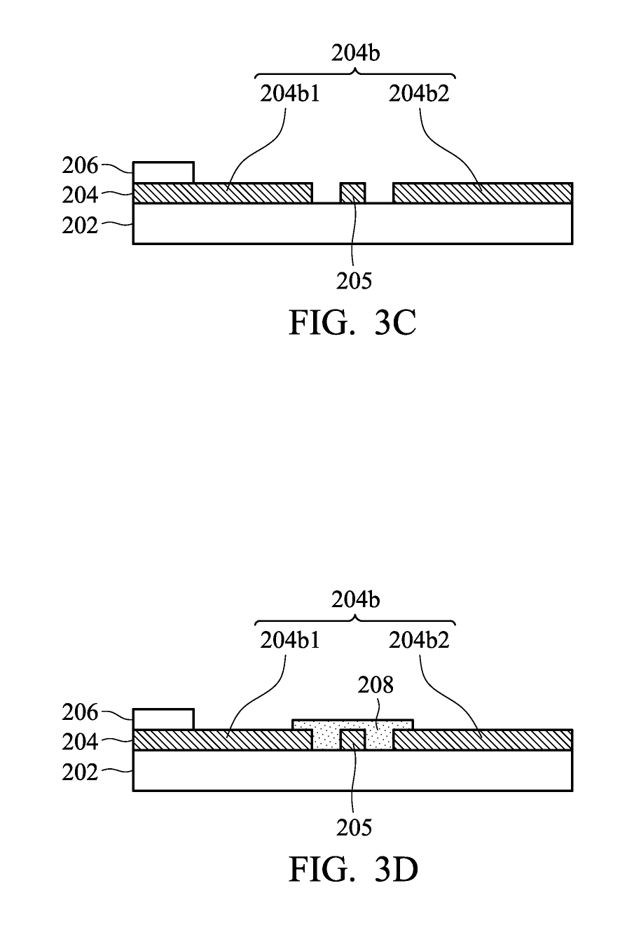

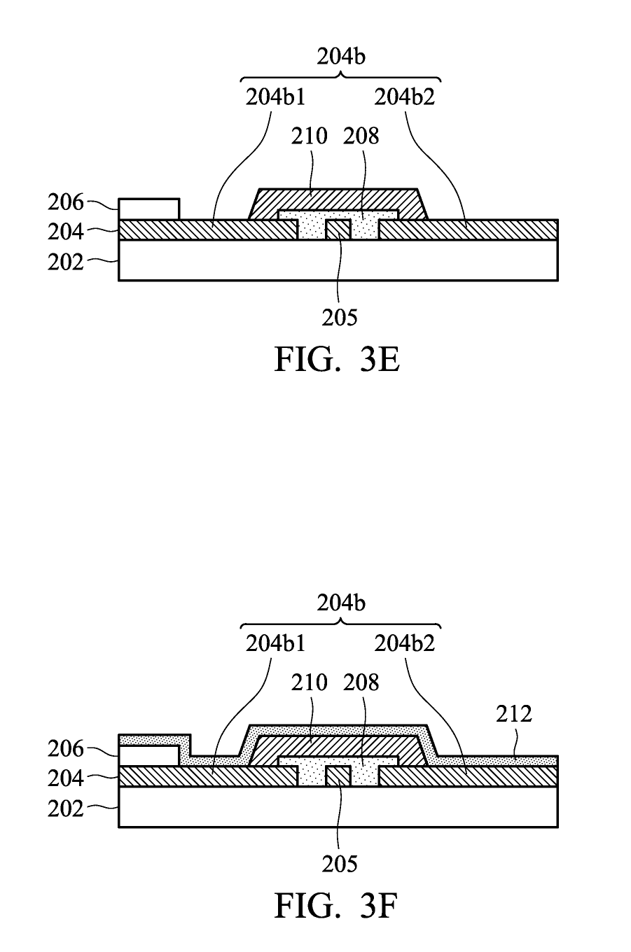

Referring to FIG. 2, which is a plan view of a display system 400 having a capacitive touch panel 200 according to one embodiment of the present invention. The capacitive touch panel 200 includes a substrate 202, an electrode circuit 204, a plurality of signal wires 206, a dielectric layer 208, an electrode bridge structure 210 and a passivation layer 212 (as shown in FIG. 3F). The electrode circuit 204 is connected to a control circuit 214 via conducting wires formed by the plurality of signal wires 206. The control circuit 214 processes the sensing signals transmitted from the electrode circuit 204.

The electrode circuit 204 is formed on the substrate 202 and has a first electrode 204a and a second electrode 204b. The first electrode 204a has a plurality of first conducting patterns 204a1 and 204a2 disposed on the substrate 202 along a first direction and the second electrode 204b has a plurality of second conducting patterns 204b1 and 204b2 disposed on the substrate 202 along a second direction. The plurality of first conducting patterns 204a1 and 204a2 are electrically connected to each other by a conducting wire 205 along the first direction (e.g., the “Y” axis), and the plurality of second conducting patterns 204b1 and 204b2 are arranged along the second direction (e.g., the “X” axis). The second electrode 204b is electrically insulated from the first electrode 204a. That is, the plurality of second conducting patterns 204b1 and 204b2 is electrically insulated from the plurality of first conducting patterns 204a1 and 204a2. In one embodiment, the plurality of first conducting patterns 204a1 and 204a2 and the plurality of second conducting patterns 204b1 and 204b2 are arranged in an array.

The plurality of signal wires 206 is formed on the substrate 202 and is electrically connected to the first electrode 204a and the second electrode 204b of the electrode circuit 204. The plurality of signal wires 206 and the electrode circuit 204 are disposed in different regions of the substrate 202. The dielectric layer 208 is formed on the electrode circuit 204 and partially covers the electrode circuit 204. For example, the dielectric layer 208 is disposed at an adjacent region among the upper first conducting pattern 204a1, the lower first conducting pattern 204a2, the left-side second conducting pattern 204b1 and the right-side second conducting pattern 204b2.

In the embodiment, the electrode bridge structure 210 of the capacitive touch panel 200 is formed on the dielectric layer 208 and the electrode circuit 204 and is electrically connected to the second electrode 204b of the electrode circuit 204, such that the plurality of second conducting patterns 204b1 and 204b2 of the electrode circuit 204 are electrically connected to each other. The electrode bridge structure 210 is electrically insulated from the first electrode 204a of the electrode circuit 204 by the dielectric layer 208. In one embodiment, the electrode bridge structure 210 has a thickness greater than that of the dielectric layer 208.

In one embodiment, the electrode bridge structure 210 is configured as a metal line formed by a metal open repair technique and has a uniform thickness, thereby reducing trace resistance of the electrode circuit 204. The metal line has a width within a range from 3.0 μm to 50 μm, a length within a range from 50 μm to 2 mm, and a thickness within a range from 0.3 μm to 10 μm. The metal line can fully cover the dielectric layer 208 when the metal line has a thickness within a range from 0.3 μm to 10 μm; however, a greater thickness may also be acceptable in some embodiments.

Referring to FIG. 2 and FIGS. 3A to 3F, in which FIGS. 3A to 3F are cross section views of a method of manufacturing the capacitive touch panel 200 shown in FIG. 2 along line A-A′ according to one embodiment of the present invention. In FIG. 3A, a first conducting layer 300 is formed on a substrate 202. A second conducting layer 302 is formed on the first conducting layer 300. The substrate 202 comprises a material selected from one group consisting of a glass, plastic and transparent material. The plastic material is selected from the group consisting of polyester resin, polyacrylate resin, polyolefin resin, polyimide resin, polycarbonate resin and polyurethane resin. For example, the polyolefin resin is polyethylene (PE) or polypropylene (PP), the polyester resin is polyethylene terephthalate (PET), and the polyacrylate resin is polymethylmethacrylate (PMMA). The first conducting layer 300 and the second conducting layer 302 may be formed by a sputtering or the physical vapor deposition (PVD) process. In one embodiment, the first conducting layer 300 may comprise indium tin oxide (ITO) and the second conducting layer 302 may comprise metal.

Referring to FIG. 3B, the second conducting layer 302 is patterned by an etching process, to form a plurality of signal wires 206 and expose the first conducting layer 300. For example, the plurality of signal wires 206 is formed by a dry or wet etching process. Referring to FIG. 2 and FIG. 3C, the first conducting layer 300 is etched to form an electrode circuit 204 having a first electrode 204a and a second electrode 204b. The first electrode 204a has a plurality of first conducting patterns 204a1 and 204a2 disposed on the substrate 202 along a first direction and the second electrode 204b has a plurality of second conducting patterns 204b1 and 204b2 disposed on the substrate 202 along a second direction. The plurality of first conducting patterns 204a1 and 204a2 arranged along the first direction (e.g., the “Y” axis) is electrically connected to each other by the conducting wire 205, and the plurality of second conducting patterns 204b1 and 204b2 is arranged along the second direction (e.g., the “X” axis). The second electrode 204b is electrically insulated from the first electrode 204a. That is, the plurality of second conducting patterns 204b1 and 204b2 is electrically insulated from the plurality of first conducting patterns 204a1 and 204a2. The electrode circuit 204 may be formed by a dry or wet etching process. In one embodiment, the substrate 202 comprises plastic and the first conducting layer 300 is etched by the etching paste to form the electrode circuit 204. In another embodiment, a protection resin is further formed on the first conducting layer 300, thereby forming the electrode circuit 204 by an etching process.

Referring to FIG. 3D, a dielectric layer 208 is formed on and partially covers the electrode circuit 204. The dielectric layer 208 may comprise silicon oxide or other transparent inorganic materials. In one embodiment, the dielectric layer 208 is formed by the screen printing technique, Asahi Kasei Photosensitive Resin (APR) coating technique or spray printing technique. The dielectric layer 208 has a thickness within a range from 0.1 μm to 5 μm.

Referring to FIG. 3E, an electrode bridge structure 210 is formed on the dielectric layer 208 and the plurality of second conducting patterns 204b1 and 204b2 of the electrode circuit 204. The electrode bridge structure 210 is electrically connected to the plurality of second conducting patterns 204b1 and 204b2 of the electrode circuit 204, such that the plurality of second conducting patterns 204b1 and 204b2 are electrically connected to each other. The electrode bridge structure 210 has a thickness greater than that of the dielectric layer 208 and the electrode bridge structure 210 is electrically insulated from the conducting wire 205 of the first electrode 204a by the dielectric layer 208. Namely, the plurality of first conducting patterns 204a1 and 204a2 of the first electrode 204a is electrically insulated from the electrode bridge structure 210 by the dielectric layer 208. The electrode bridge structure 210 may comprise an alloy material selected from the group consisting of palladium (Pd), platinum (Pt), aurum (Au), argentums (Ag) and aluminum (Al). In one embodiment, the electrode bridge structure 210 is configured as a metal line formed by a metal open repair technique. The metal line may be formed by wire bonding. In one embodiment, the metal line has a width within a range from 3.0 μm to 50 μm, a length within a range from 50 μm to 2 mm, and a thickness within a range from 0.3 μm to 10 μm.

Referring to FIG. 3F, a passivation layer 212 is formed on the electrode circuit 204, the plurality of signal wires 206 and the electrode bridge structure 210. The passivation layer 212 may comprise silicon oxide or other inorganic materials. The passivation layer 212 has a thickness within a range from 0.1 μm to 5 μm. In one embodiment, the passivation layer 212 may be formed by the screen printing technique, Asahi Kasei Photosensitive Resin (APR) coating technique or spray printing technique.

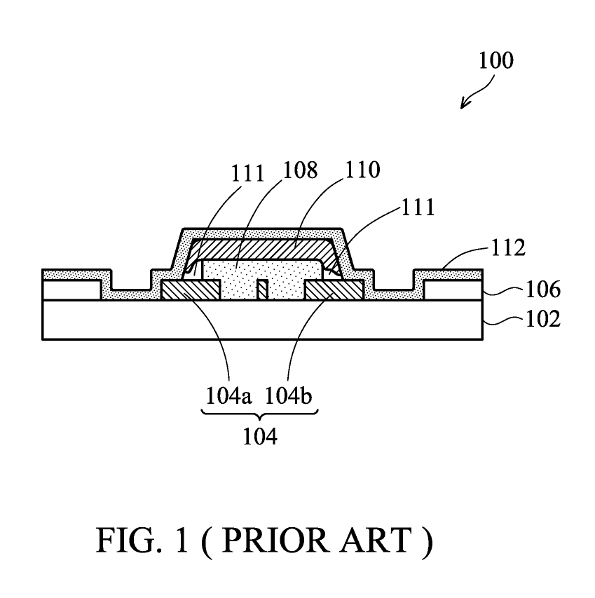

According to the above-mentioned descriptions, in comparison with the stacked layer 110 (as shown in FIG. 1) formed by a lithography and etching process in the art, the electrode bridge structure 210 of the capacitive touch panel 200 having an uniform thickness and formed by a metal open repair technique is employed to electrically connect between the plurality of second conducting patterns 204b1 and 204b2, thereby reducing trace resistance of the electrode circuit 204. That is, the second conducting pattern 204b1 is electrically connected to the second conducting pattern 204b2 opposite thereto via the electrode bridge structure 210 for accurately transmitting the sensing signal to the control circuit 214.

Further, the contact interfaces between the two ends of the electrode bridge structure 210 and the plurality of second conducting patterns 204b1 and 204b2 have good ohmic contact. That is, the trace resistance between the electrode bridge structure 210 and the plurality of second conducting patterns 204b1 and 204b2 is effectively reduced, such that the problem of poor electrical contact, which results from the defects formed in the contact interfaces, can be mitigated or eliminated. Therefore, the electrode bridge structure 210 formed by a metal open repair technique can be used to replace the stacked layer 110 formed by conventional lithography and etching processes.

Moreover, the electrode bridge structure 210 of the embodiment is suitable applied to the dielectric layer 208 with different thicknesses and electrode circuit 204, this is because the thickness of the electrode bridge structure 210 is greater than that of the dielectric layer 208 and the electrode bridge structure 210 has good extensibility. Thus, when a step edge is produced between the dielectric layer 208 and electrode circuit 204, the electrode bridge structure 210 is not stripped off and can still cover the dielectric layer 208 and be electrically connected between the lift-side second conducting patterns 204b1 and the right side second conducting patterns 204b2. In other words, the thickness of the dielectric layer 208 has no effect on the formation of the electrode bridge structure 210. Therefore, since it is unnecessary to precisely control the thickness of the dielectric layer 208 for formation of the electrode bridge structure 210, the flexibility for selection of materials of the dielectric layer 208 is increased, thereby increasing the yield of the capacitive touch panel 200.

Meanwhile, if the substrate comprises plastic, the formation of the electrode bridge structure 210 is severely restricted by the use of the PVD process. On the contrary, the formation of the electrode bridge structure 210 is not severely restricted by the use of the PVD process as the electrode bridge structure 210 can be formed on the substrate 202 (e.g., a plastic substrate) by the metal open repair technique, thereby effectively increasing the yield of the capacitive touch panel 200.

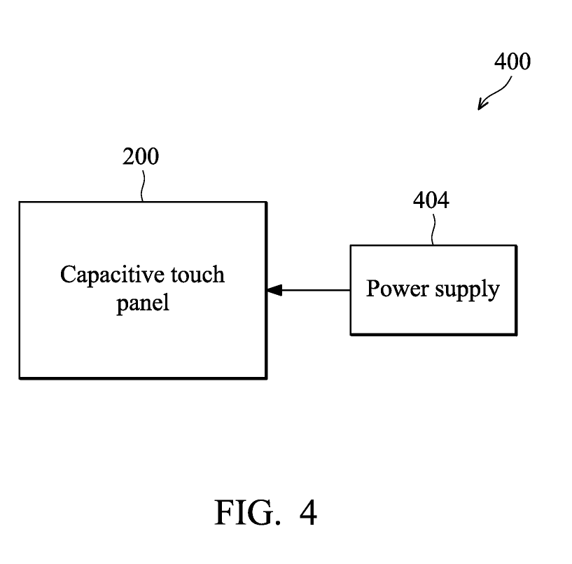

Referring to FIG. 4, which is a schematic block diagram of the display system 400 having a capacitive touch panel 200 according to one embodiment of the present invention. The display system 400 includes a capacitive touch panel 200 and a power supply 404. The power supply 404 is electrically connected to the capacitive touch panel 200 for supplying power thereto. The display system 400 is selected from one group consisting of a mobile phone, a digital camera, a personal digital assistant (PDA), a notebook computer, a desktop computer, a television set, a global positioning system (GPS), an automobile display, a flight display, and a portable digital versatile disk (DVD).

According to the aforementioned descriptions, the present invention provides a display system having a capacitive touch panel and a manufacturing method thereof for effectively reducing trance resistance of the conducting layers and improving the step coverage. Moreover, the flexibility for selection of the materials of the electrode bridge structure, the dielectric layer and the passivation layer is increased, thereby improving the yield of the capacitive touch panel.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display system having a capacitive touch panel, wherein the capacitive touch panel comprises:
a substrate;
an electrode circuit formed on the substrate and having a first electrode along a first direction and a second electrode along a second direction, wherein the first electrode comprises a plurality of first conducting patterns electrically connected to each other and the second electrode comprises a plurality of second conducting patterns electrically insulated from the first electrode;
a plurality of signal wires formed on the substrate and electrically connected to the first electrode and the second electrode of the electrode circuit;
a dielectric layer formed on the electrode circuit and partially covering the electrode circuit; and
an electrode bridge structure formed on the dielectric layer and the electrode circuit, and electrically connected to the second conducting patterns of the electrode circuit, such that the second conducting patterns are electrically connected to each other, wherein the electrode bridge structure has a thickness greater than that of the dielectric layer and the electrode bridge structure is electrically insulated from the first electrode of the electrode circuit by the dielectric layer.

2. The display system of claim 1, wherein the substrate comprises a material selected from one group consisting of a glass, plastic and transparent material.

3. The display system of claim 1, wherein the dielectric layer has a thickness within a range from 0.1 μm to 5 μm.

4. The display system of claim 1, wherein the electrode bridge structure comprises an alloy material.

5. The display system of claim 1, wherein the electrode bridge structure is configured as a metal line which is formed by a metal open repair technique.

6. The display system of claim 5, wherein the metal line has a width within a range from 3.0 μm to 50 μm, a length within a range from 50 μm to 2 mm, and a thickness within a range from 0.3 μm to 10 μm.

7. The display system of claim 1, further comprising a power supply electrically connected to the capacitive touch panel to supply power thereto, wherein the display system is selected from one group consisting of a mobile phone, a digital camera, a personal digital assistant (PDA), a notebook computer, a desktop computer, a television set, a global positioning system (GPS), an automobile display, a flight display, and a portable digital versatile disk (DVD).

8. A method of manufacturing a display system having a capacitive touch panel comprising:
forming a first conducting layer on a substrate;
forming a second conducting layer on the first conducting layer;
patterning the second conducting layer to form a plurality of signal wires and expose the first conducting layer;
etching the first conducting layer to form an electrode circuit having a first electrode along a first direction and a second electrode along a second direction, wherein the first electrode comprises a plurality of first conducting patterns electrically connected to each other and the second electrode comprises a plurality of second conducting patterns electrically insulated from the first electrode;
forming a dielectric layer on the electrode circuit to partially cover the electrode circuit; and
forming an electrode bridge structure on the dielectric layer and the electrode circuit, and electrically connected to the second conducting patterns of the electrode circuit, such that the second conducting patterns are electrically connected to each other, wherein the electrode bridge structure has a thickness greater than that of the dielectric layer and the electrode bridge structure is electrically insulated from the first electrode of the electrode circuit by the dielectric layer.

9. The method of claim 8, wherein the substrate comprises a material selected from one group consisting of a glass, plastic and transparent material.

10. The method of claim 8, wherein the dielectric layer has a thickness within a range from 0.1 μm to 5 μm.

11. The method of claim 8, wherein the electrode bridge structure comprises an alloy material.

12. The method of claim 8, wherein the electrode bridge structure is configured as a metal line which is formed by a metal open repair technique.

13. The method of claim 12, wherein the metal line has a width within a range from 3.0 μm to 50 μm, a length within a range from 50 μm to 2 mm, and a thickness within a range from 0.3 μm to 10 μm.
